(19) United States
(12) Patent Application Publication
(10) Pub. No.: US 2008/0078919 A1
(43) Pub. Date: Apr. 3, 2008

(54) Device and method for floor-side attachment of a turbomachine

(76) Inventor: Henning Struck, Wesseling (DE)

Correspondence Address: COLLARD & ROE, P.C., 1077 NORTHERN BOULEVARD, ROSLYN, NY, 11576, US

(21) Appl. No.: 11/888,267

(22) Filed: Jul. 31, 2007

(30) Foreign Application Priority Data
Sep. 29, 2006 (DE) DE 102006046809.0

(51) Int. Cl. F16M 5/00; F16M 7/00

(52) U.S. Cl. 248/637; 52/173.1; 52/741.1

(57) ABSTRACT

A method and a device for floor-side attachment of a turbomachine, particularly on a ship or an offshore technology facility, having at least one accommodation frame that accommodates the turbomachine. The frame has at least one floor surface on which the accommodation frame is supported in the attached state, and attachment means disposed in the region of the floor surface for attaching the accommodation frame on a floor-side contact surface. The floor surface is roughened up in order to increase the adhesion friction between floor surface and contact surface.

### BACKGROUND OF THE INVENTION

1. Field of the Invention

The invention relates to a device for floor-side attachment of a turbomachine, particularly on a ship or an offshore technology facility. The attachment has at least one accommodation frame that accommodates the turbomachine. The frame has at least one floor surface on which the accommodation frame is supported in the attached state. There are attachment means disposed in the region of the floor surface for attaching the accommodation frame on a floor-side contact surface. A method for floor-side attachment of a turbomachine is also an object of the invention.

2. The Prior Art

Usually, the frames of turbomachines are screwed onto the foundation provided for this purpose. This is not a problem in the case of fixed foundations in which no acceleration in the direction of the foundation plane have to be absorbed. In the case of the installation of a turbomachine on a moving substratum, however, for example on a ship, or in general on an offshore technology facility that is exposed to vibrations and/or shocks, there is the problem that very great crosswise forces have to be absorbed in the foundation plane or deck plane, in order to avoid a displacement of the turbomachine relative to the foundation or deck. Thus, in the case of heavy turbomachines, the standardized screw connection frequently cannot be implemented. Instead, the attachment must take place by means of a very much greater number of attachment screws. As an alternative to this, it is also known to produce the attachment of the turbomachine by means of weld connections. However, this measure frequently cannot be implemented in practice.

### SUMMARY OF THE INVENTION

It is therefore an object of the invention to provide a device for floor-side attachment of a turbomachine that guarantees secure locking of the turbomachine even in the case of shocks and/or vibrations parallel to the floor plane, in a simple manner.

This object is accomplished, according to the invention, in that at least one of the floor surfaces is roughened up in order to increase the adhesion friction between floor surface and contact surface. The invention increases the maximally absorbable crosswise force Qₘₐₓ, which is calculated according to the formula

Qₘₐₓ=μ*F

not by increasing the contact pressure force between floor surface and contact surface, but instead by increasing the adhesion friction number μ. Preferably, the floor surface is processed in a separate process for this purpose, such as sand-blasting.

The accommodation frame can have several support feet, the undersides of which represent the floor surfaces. The attachment means can be configured as screws that pass through bores in the support feet.

The invention also comprises a method for floor-side attachment of an accommodation frame of a turbomachine, the frame having at least one floor surface, on a contact surface that is particularly situated on a ship or an offshore technology facility. The attachment takes place by attachment means provided in the region of the floor surface. According to the invention, the floor surface and/or the contact surface is/are roughened up in order to increase the adhesion friction between these surfaces. Adhesion friction numbers μ of up to 0.5 can be reached by sand-blasting the floor surface and/or the contact surface.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a three-dimensional side view of several frames for accommodation of a turbomachine;

FIG. 2 shows a detailed enlargement of FIG. 1; and

FIG. 3 shows a representation of the forces that are in effect in the region of the detail shown in FIG. 2.

### DETAILED DESCRIPTION OF THE PREFERRED EMBODIMENT

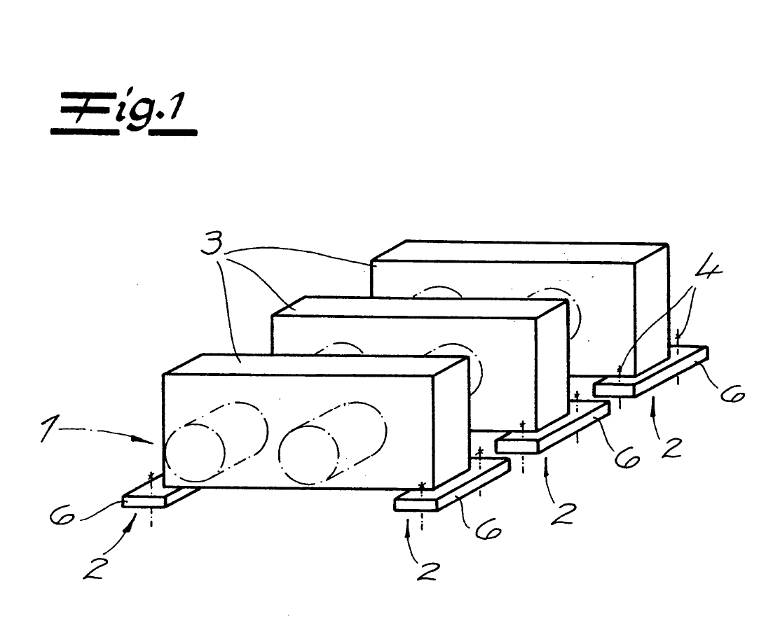

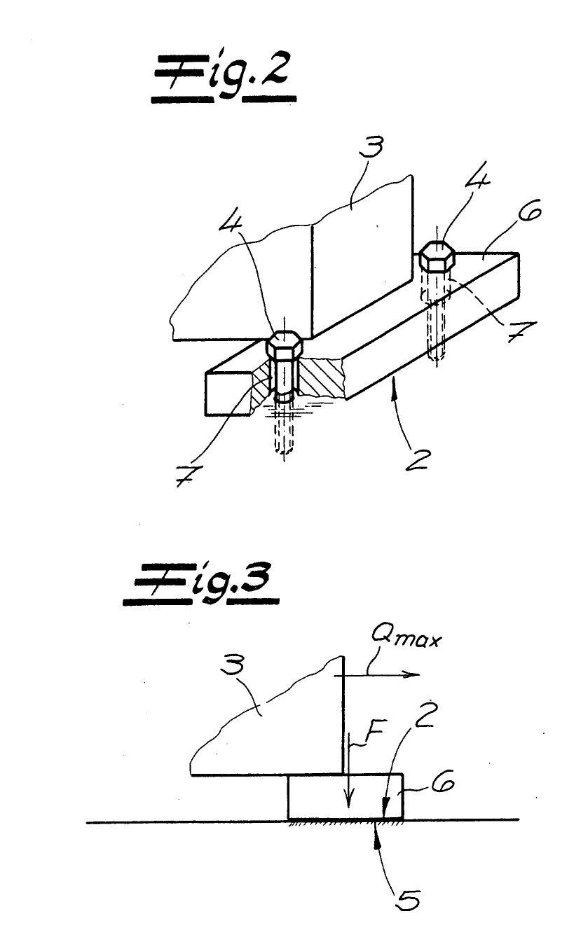

Referring now in detail to the drawings, FIG. 1 shows a device for floor-side attachment of a turbomachine 1 that is shown without a motor and a core unit. The device attaches turbomachine 1 on a ship or an offshore technology construction. The device has several accommodation frames 3 that accommodate turbomachine 1, each having two floor surfaces 2 on which accommodation frames 3 are supported in the attached state. FIGS. 2 and 3, show attachment means 4 for attaching the accommodation frames 3 on a floor-side contact surface 5 of the ship or the offshore technology facility are provided in the region of floor surfaces 2. Attachment means 4 can be screws, or can be any other suitable attachment means, such as bolts, rivets, clamps, etc. Floor surfaces 2 and the related contact surfaces 5 are roughened up by a sand-blasting process, in order to increase the adhesion friction between floor surface and contact surface 2, 5. Accommodation frames 3 have two support feet 6, in each instance, whose undersides represent floor surfaces 2. FIG. 2 shows that attachment means 4 are configured as screws that pass through bores 7 in support feet 6.

FIG. 3 shows the forces that are in effect in the region of support feet 6. The undersides of support feet 6, which represent floor surfaces 2, are pressed against contact surfaces 5 with a force F, the amount of which depends on the weight of frames 3 and of turbomachine 1, as well as on the bias force of screws 4. The maximally absorbable crosswise force Qₘₐₓ is proportionally dependent both on force F and on the adhesion friction number μ that is in effect between floor surface 2 and contact surface 5. According to the invention, an increase in the maximally absorbable crosswise force Qₘₐₓ is achieved by an increase in the adhesion friction number μ, instead of an increase in the contact pressure force F.

Accordingly, while only a few embodiments of the present invention have been shown and described, it is obvious that many changes and modifications may be made thereunto without departing from the spirit and scope of the invention.

What is claimed is:

1. A device for floor-side attachment of a turbomachine, comprising:
at least one accommodation frame that accommodates the turbomachine, said at least one frame having at least one floor surface on which each accommodation frame is supported in an attached state; and
attachment means disposed in a region of said at least one floor surface for attaching the accommodation frame to a floor-side contact surface;
wherein at least one of said at least one floor surface is roughened up in order to increase adhesion friction between said at least one floor surface and said contact surface.

2. A device according to claim 1, wherein said at least one floor surface is sand-blasted.

3. A device according to claim 1, wherein the accommodation frame has several support feet whose undersides form said floor surfaces.

4. A device according to claim 3, wherein the attachment means are configured as screws that pass through bores in the support feet.

5. A method for floor-side attachment of an accommodation frame of a turbomachine to a contact surface, the frame having at least one floor surface, the method comprising the following steps:
roughening up at least one of said at least one floor surface and the contact surface; and
attaching said frame to said contact surface via attachment means provided in a region of the floor surface.

6. A method according to claim 5, wherein at least one of the at least one floor surface and the contact surface are sand-blasted.

7. A method according to claim 6, wherein the attachment means are screws.
